(19) United States
(12) Patent Application Publication
(10) Pub. No.: US 2003/0064137 A1
(43) Pub. Date: Apr. 3, 2003

(54) Iced confectionery article and process for preparing it

(76) Inventors: Philip Ignor Cathenaut, Ecouen (FR); Veronique Cossin, Beauvais (FR); Bruno Delande, Marseille en Beauvaisi (FR)

Correspondence Address: WINSTON & STRAWN, PATENT DEPARTMENT, 1400 L STREET, N.W., WASHINGTON, DC, 20005-3502, US

(21) Appl. No.: 10/300,030

(22) Filed: Nov. 20, 2002

Related U.S. Application Data
(63) Continuation of application No. PCT/EP01/06147, filed on May 30, 2001.

(30) Foreign Application Priority Data
May 31, 2000 (EP) 00201932.1

(51) Int. Cl. A23G 1/00

(52) U.S. Cl. 426/103

(57) ABSTRACT

An iced confectionery article, which is in particular a molded iced confectionery article based on water ice with a soft-core texture. This article includes i) a core of water ice containing 20 to 40% by weight of solids, having a degree of overrun of 20 to 80% and a texture which is similar to that of an extruded ice-cream, which contains, where appropriate, pieces, and ii) a shell of water ice with no overrun, containing 20 to 35% by weight of solids. In another embodiment, the core contains inclusions ranging in size from 1 to 10 mm. The invention also relates to processes for preparing these molded iced confectionery articles.

### CROSS-REFERENCE TO RELATED APPLICATIONS

This application is a continuation of the U.S. national stage designation of International application PCT/EP01/06147 filed May 30, 2001, the entire content of which is expressly incorporated herein by reference thereto.

### TECHNICAL FIELD

The invention relates to the field of iced confectionery articles based on water ice. It relates more particularly to a molded iced confectionery article based on water ice with a soft-core texture.

### BACKGROUND ART

Iced confectionery articles of the water ice type are generally manufactured by filling a composition for water ice which is liquid at positive temperature, about 2-3° C., into molds generally made of heat-conducting metal circulating in refrigerant surroundings which cause the composition for water ice to freeze slowly by conduction. The refrigerant surroundings can be a bath of liquid refrigerant, for example brine, or a freezing tunnel with a cold-air flow in which the molds circulate.

Once frozen, the articles can be left in the molds which, at the same time, are used as packaging, for example in the case of small cylinders with a “push-up” device or pliable cases in the form of a cylinder flattened at one of its ends.

It is also possible to insert a stick into the mass of the iced composition which has not yet solidified through to the core, to continue the solidification, to de-mold the articles by heating the outer surface of the mold, to harden them and then to wrap them, for example in soft sachets or “flow-packs”.

Such molded articles generally have a hard texture due to the slow and progressive freezing by conduction, which generates large crystals of ice. Composite iced confectionery articles having a soft texture are known, which consist, in particular, of a core of extruded overrun ice-cream coated with a composition of water ice. These are described, for example, in EP-A-0710074 or WO-A-9804149. The soft texture of the coating is obtained in these processes by immersing the pre-cooled extruded core in a composition for water ice and cooling very rapidly to a temperature <−15° C., for example by dipping in liquid nitrogen so as to harden the coating. It is generally necessary to carry out several successive cycles of dipping and hardening in order to obtain the desired coating thickness.

While these products are useful, it would be desirable to have an iced confection that has a supple texture, and the present invention now satisfies this need.

### SUMMARY OF THE INVENTION

The invention relates to iced confectionery articles, i.e., those based on water ice, which, in particular, are molded and have a supple texture.

One embodiment of this article comprises:

i) a core of water ice containing 20 to 40% by weight of solids, and having a degree of overrun of 20 to 80% and a texture which is similar to that of an extruded ice-cream, and

ii) a shell of water ice with no overrun, containing 20 to 35% by weight of solids.

Another embodiment of the invention relates to a molded iced confectionery article based on a water ice of a second type, which has a core as defined above and contains edible inclusions ranging in size from 1 to 10 mm.

The invention also relates to processes for preparing these molded iced confectionery articles.

### BRIEF DESCRIPTION OF THE DRAWING

FIG. 1 is a schematic representation of a manufacturing line that includes one measuring-out track for the distribution of water ice in accordance with the invention.

### DETAILED DESCRIPTION OF THE PREFERRED EMBODIMENTS

In this invention, one feature of the core of water ice is that it contains a stabilizer with gelling properties. This stabilizer can be chosen from carob gum, xanthan gum, guar gum, tara gum, carboxymethylcellulose, gelatin, alginates, carrageenan, starches, pectins and microcrystalline cellulose, or a mixture of such ingredients.

Xanthan gum, carob gum, gelatin and pectins are preferably used, and more specifically a mixture comprising xanthan gum and carob gum wherein the xanthan gum is predominant, or a mixture comprising gelatin and carob gum where the gelatin is predominant.

The amount of stabilizing mixture in the core is <or =0.5% by weight, and is preferably 0.3 to 0.4% by weight.

The nature of the stabilizing mixture and the stabilizing mixture content, in combination with the solids content of the core, allows it to be treated and overrun in the freezer to give it a texture similar to that of extruded ice-cream emerging from the freezer at approximately −5 to −6° C.

In the context of the invention, the degree of overrun can be defined as the increase in volume of the mix due to the incorporation of air, expressed as percentage of volume. It is preferably 30 to 50%.

Advantageously, the core has a solids content of 28 to 32% by weight. In addition to the stabilizing mixture, said solids of the core advantageously originate:

for up to 20% by weight, from fruit puree, from flavor and/or from colorant, and

for 20 to 27% by weight, from carbohydrates, including up to 7% by weight from glucose syrup.

A fruit puree or, as a variant, a fruit flavor and a colorant can be and preferably is used.

The composition of the water ice of the shell must be such that its texture is firm without being too hard. It does not contain any air incorporated other than as a result of mixing its components, i.e., it is not overrun.

The solids of the shell constitute preferably 25 to 30% by weight of the shell and advantageously originate:

for 3 to 5% by weight, from fruit puree or fruit juice, from flavor and/or from colorant, for 0.35 to 0.45% by weight, from a stabilizer with viscosity-modifying properties, and

for 20 to 26% by weight, from carbohydrates.

The stabilizer with viscosity-modifying properties can be chosen from guar gum, carob gum, xanthan gum, carboxymethylcellulose, pectins, carrageenans and starches, or mixtures of these ingredients, with guar gum being preferred.

The shell can contain extracts of spices, of coffee, of cocoa, or of honey or a syrup, for example maple syrup, or an alcohol or liqueur flavor.

The carbohydrates of the shell advantageously are sucrose. It is also possible to use sucrose in a dominant amount, with glucose syrup and of 8 to 10% of invert sugar.

In a preferred embodiment, the iced confectionery article according to the invention is an ice-lolly in which the core and the shell have a fruit-based flavor and color and preferably containing a considerable amount of fruit, in particular an extract, for example a fruit puree or a fruit flavor.

The ice-lolly can preferably have the shape of a cone frustum having an oval base and cross section, with a rounded top and a volume of 60 to 120 ml.

The core and the shell can constitute contrasting or combined tastes, for example by combining a fruit flavor, for example an acid fruit flavor, and an aromatic extract of an alcohol or of a liqueur.

The core can contain inclusions, in particular dry or candied pieces of fruit, pieces of jelly or fondant, crunchy pieces or pieces of sauce, of caramel, of chocolate, of sugared confectionery or of biscuit, and preferably, pieces or splinters of fruit, for example of the same fruit contained in the puree or extract in the core mass.

The sugars and stabilizers of the shell can be chosen so as to produce a reasonably noticeable contrast in texture with the core. The shell is not only used to maintain the shape of the product, but can also guarantee good resistance to melting and to heat shock. Other stabilizers, such as for example pectins or starches, can be added thereto if desired.

The thickness of the shell is 1 to 5 mm, and preferably 2 to 3 mm.

The invention also relates to a molded iced confectionery article based on water ice of a second type, consisting of a core as defined above and containing edible inclusions ranging in size from 1 to 10 mm. The inclusions of the types mentioned above are suitable for this purpose.

Such an article can be coated with a fatty composition, such as a covering of chocolate or of compound mix. The coating composition in question can also contain additional substances, such as pieces of dried fruit or particles of toasted or puffed cereals. The coating can consist of multiple layers.

The invention also relates to a process for preparing a composite iced confectionery article above, in which a mold, maintained in a refrigerated atmosphere, is filled with a composition of water ice, which has not been overrun and which is liquid. The mold is cooled so as to form an open shell by freezing the liquid composition in contact with the interior wall of the mold, and then drawing off part of the center of the composition that is still liquid. A composition of water ice, which is frozen and has a degree of overrun of 20 to 80%, is introduced into the open shell to constitute the core of the article. If desired or appropriate, a stick can be introduced. The formation of the shell is completed by adding the required amount of the liquid composition of water ice, before or after inserting the stick, and the article is hardened and then de-molded.

According to another embodiment of the process for preparing a composite iced confectionery article above, the core is manufactured while introducing inclusions ranging in size from 1 to 10 mm into it, it is cooled and it is coated with a composition constituting the shell as defined above.

According to a second embodiment of the process for preparing an iced confectionery article of the second type above, the mold, maintained in a refrigerated atmosphere, is filled with a composition of water ice, that is frozen and has a degree of overrun of 20 to 80%, to constitute the core of the article. As above, where appropriate, a stick is introduced. The core is hardened, the product de-molded and, where appropriate, it is coated with a fatty composition, in particular a chocolate covering.

Whatever the embodiment of the process, the measuring out of the composition of water ice which constitutes the core of the article requires specific means making it possible to fill the molds or cavities created by the “shell and core” method with a relatively hard and viscous material which contains, where appropriate, inclusions from 1 to 10 mm in size, without forming air pockets, e.g., in the lower portions or bottom of the molds.

These means can include a dispenser/distributor that is connected to the freezer, maintained under pressure by the freezer, and operates in combination with a measuring-out device.

In the context of the invention, a relatively hard and viscous material is an overrun water ice at −2° C. to −6° C., preferably at −5° C. to −6° C., emerging from a freezer. It has a firmer texture and a percentage of frozen water with respect to the total water of the recipe that is higher than a conventional liquid composition to be frozen, this being more or less pronounced depending on the composition of the mixture to be frozen.

The specific means can be applied to any machine for freezing iced confectionery articles, such as for example:

a machine for freezing in brine, which is rectilinear, rotary, oval or in square movement,

a freezing machine which uses a liquid, gaseous or evaporating refrigerating fluid, which immerses the molds or sprays them for reasonably long periods,

a machine in which the molds are transported by a conveyor in a pulsed-air tunnel to effect deep-freezing, the conveyor possibly being rectilinear or winding, for example as a single or double helix, which is flattened or has revolutions, or

any machine of the above type in which the displacement of the molds is continuous or stepwise.

Thus, the specific means can be applied very simply to existing machines.

This principle of measuring out under pressure can apply to various types of measuring-out devices, such as for example measuring-out devices with a dispensing casing and with vertical or horizontal cylinders, measuring-out devices with valves or preferably measuring-out devices with immersed nozzles of the “bottom-up filler” type combined with up-and-down devices and coupled to a rotary valve. The valve opening time/frozen mix pressure pairing defines the amount of material to be measured out and dispensed into the product.

When multi-track measuring out is implemented, the ice is distributed homogeneously between the various outlet pipes of a dispenser/distributor and can fill up the measuring-out devices without creating an air pocket. The up-and-down device ensures complete filling of the mold without creating an air pocket.

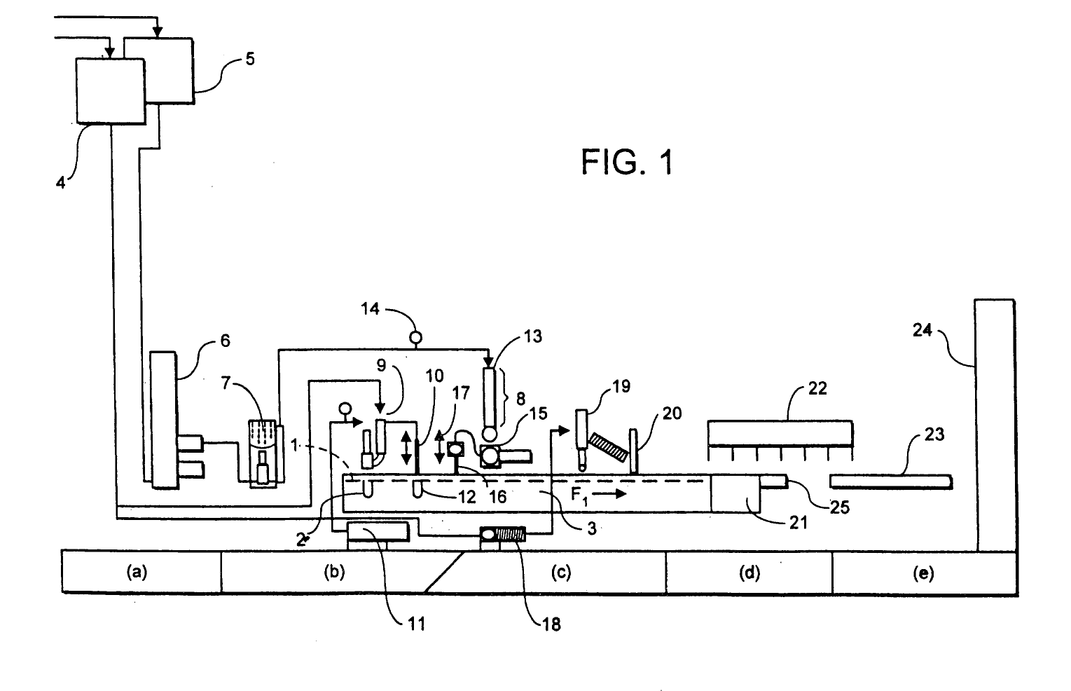

The implementation of the process is described hereinafter by way of example, in conjunction with the attached drawing that illustrates a preferred embodiment. For clarity, the manufacturing line that is schematically represented in FIG. 1 shows only one measuring-out track.

As shown in FIG. 1, in order to implement the process, a conventional molding line is preferably used. This line includes a table 1 of molds 2 in stepwise horizontal translational movement according to fl, that advance successively in a refrigerant bath 3, for example of brine at approximately −40° C., for the mold-filling (b) and freezing (c) operations, and in a zone in which brine, water or steam is sprayed to effect reheating of the molds sufficiently to facilitate de-molding and extraction (d) of the articles.

For preparing sorbets (a), the shell mix is prepared in tank 4 and the core mix is prepared in tank 5 according to a conventional method of pasteurization after homogenization and maturation at approximately 4° C. for approximately 4 h. Tank 5 is connected to the freezer 6, and inclusions are introduced and mixed into the frozen mix emerging from the freezer by means of a feed device 7. At the outlet of the device 7, the frozen mix containing the inclusions is directed towards the device for measuring out the core 8.

Initially, a volumetric-type measuring-out device 9 ensures on-line and simultaneous filling of the molds of the same line with the shell mix coming from tank 4. An up-and-down device 10 connected to a vacuum pump 11 (or, alternatively, a system of syringes, not shown) effects the aspiration of the central part of the non-frozen mix, at a distance from the first measuring out which conditions, along with the rate at which the table is advancing, the thickness of the shell 12.

The step for measuring out the core follows that of shell formation. When running, a static or dynamic dispenser/distributor 13, for example with an internal mixer element, ensures homogeneous distribution of the frozen mix. The dispenser/distributor 13 is fed continuously by the freezer 6, and the flow rate is compared to a set value, which can generate a signal which acts to close a valve 14 or to decrease the rate of the feed pump for the product coming from the freezer, so as to decrease its flow rate. The dispenser/distributor thus delivers the frozen mix containing the inclusions in a homogeneous manner to the orifices, the number of which is identical to that of the measuring-out heads. The rate of rotation of the dynamic mixer can vary, for example, from 30 to 90 rpm.

The system for measuring out the core consists of a cylinder (not shown), of a rotary valve turning in a casing 15 and of delayed measuring-out nozzles 16. The amount measured out depends on the pressure supplied by the freezer and on the opening time of the rotary valve. The measuring-out nozzles 16 move in vertical translation by means of an up-and-down device 17. The up-and-down function ensures distribution of the viscous mass of the frozen mix from the bottom to the top of the mold, the measuring out taking place during the upward motion. The vertical movement of the nozzle is effected by a cylinder, the movement of which is adjusted such that the distance travelled by the nozzle from a low level close to the bottom of the mold to the upper filling level of the mold. A system can be envisaged which makes it possible to avoid the formation of a measuring-out tail of iced confection, for example by any means producing an acceleration of the upward return of the nozzle at the end of the movement or a vacuum in the nozzle.

After measuring out the core, additional measuring out with the shell mix, coming from tank 4, preferably cooled between 0° C. and +4° C. by the exchanger 18, ensures the closing of said shell by means of the measuring out device 19. This measuring out can be preceded or followed by stick insertion at station 20. In both cases, the core is sufficiently viscous for the stick insertion to take place within a very short period of time after measuring out the core.

Once the whole article has hardened, it is de-molded by reheating the surface of the mold at 21, and it is extracted in zone (d). The composite product is taken up by the chain 22, wrapped at 23 and stored at 24 at −30° C. to −35° C. in the wrapping and storage zone (e).

When no shell is to be formed, the core is measured out directly into the mold using the device 8 and, after stick insertion at 20, hardening and de-molding, the product it can be coated at 25, by dipping, spraying or coating per se.

The advantages provided by the process with respect to conventional molding processes are multiple.

it is possible to measure out the core ice which contains more water in the frozen state than conventionally, with a corresponding improvement in the texture, which is that conventionally found only in extruded articles.

the freezing time can be reduced by approximately 25%, which enables the line to work at a higher rate and with greater productivity.

the viscosity of the ice is such that the inclusions which it contains, where appropriate, can be distributed evenly without them settling out as in the case of a liquid ice which is measured out.

it is possible to manufacture so-called “three-dimensional” or “non-demoldable” articles by using multi-part molds.

It may be envisaged that the refrigerated environment of the molding line is very cold, such that, once hardened in the mold, the article does not adhere to the wall and can be de-molded without it being necessary to heat the mold at the surface.

The articles, since they are colder, can then be coated more easily.

### EXAMPLES

The examples hereinafter illustrate the invention. In these examples, the parts and percentages are weight parts and percentages, unless otherwise indicated.

### Example 1

### Preparation of a “Shell and Core” Frozen Stick

A mix for raspberry sorbet which constitutes the water ice of the core is prepared using the following ingredients, in the proportions given:

| Ingredient | % |
|---|---|
| Water | 55.82 |
| Glucose syrup | 6.32 |
| Xanthan gum | 0.18 |
| Carob gum | 0.12 |
| Trisodium citrate | 0.3 |
| Citric acid | 0.25 |
| Crystallized sucrose | 20.4 |
| Raspberry purée | 16. |
| Raspberry flavor | 0.16 |
| Natural red colorant | 0.25 |
| Lactoproteins | 0.2 |

The ingredients are mixed at a temperature greater than or equal to 60° C., with stirring, until suitable dissolution and hydration are obtained, the mix is homongenized and pasteurized, and then it is cooled and left to mature at +4° C. with slow stirring. After passing through a freezer with aeration, a frozen composition of water ice 40% overrun, having a temperature of −5 to −6° C., is obtained.

10% of small pieces of crushed raspberry which have been passed through a sieve with a mesh size of approximately 0.8 mm are added to the overrun mass.

A mix for water ice which constitutes the shell is prepared using the ingredients hereinafter, in the proportions given:

| Ingredient | % |
|---|---|
| Water | 68 |
| Guar gum | 0.4 |
| Glucose syrup | 6.3 |
| Crystallized sucrose | 19.6 |
| Raspberry purée | 5 |
| Citric acid | 0.22 |
| Raspberry flavor | 0.13 |
| Natural red colorant | 0.35 |

The ingredients are mixed at a temperature greater than or equal to 60° C., with stirring, until suitable dissolution and hydration are obtained, the mix is homogenized and pasteurized, and then it is cooled to +4° C.

Molds for frozen sticks having an oval cross section with a rounded bottom are filled with liquid water ice mix prepared according to 2 above at +4° C. and are plunged into a brine at −35° C. After formation of a frozen layer approximately 2 mm thick in the region of the lateral wall of the molds, the unfrozen liquid of the center is drawn off, which forms cavities of ice.

The cavities are then filled with the overrun frozen mix prepared according to 1 above at −5° C. to −6° C., using a dispenser/distributor under 2 bar of pressure, connected to a delayed measuring-out device with an immersed nozzle which descends to the bottom of the cavities and fills them during the upward return, thereby avoiding the formation of air pockets. An additional mix prepared according to 2 above is measured out and cooled between 0° C. and +4° C. so as to close the cavities and complete the shells; a stick is inserted into the still semi-frozen center, and freezing is continued. After this additional mix has solidified, the exterior wall of the molds is reheated, and the articles are extracted, wrapped and hardened at −30° C. to −35° C.

### Example 2

### Preparation of “Shell and Core” Frozen Stick

Using the same procedure as in Example 1, a composite frozen stick is manufactured using a mix 1 for orange sorbet which constitutes the water ice of the core, prepared using the following ingredients, in the proportions given:

| Ingredient | % |
|---|---|
| Water | 69.608 |
| Glucose syrup | 6.3 |
| Xanthan gum | 0.24 |
| Carob gum | 0.16 |
| Trisodium citrate | 0.4 |
| Citric acid | 0.41 |
| Crystallized sucrose | 20.6 |
| Concentrated orange juice | 2 |
| Orange flavor | 0.07 |
| Yellow colorant and carotene | 0.012 |
| Lactoproteins | 0.2 |

And a mix 2 constituting the shell, prepared using the following ingredients, in the proportions given:

| Ingredient | % |
|---|---|
| Water | 72.78 |
| Guar gum | 0.4 |
| Glucose syrup | 6.3 |
| Crystallized sucrose | 18 |
| Concentrated orange juice | 2 |
| Citric acid | 0.41 |
| Orange flavor | 0.07 |
| Yellow colorant and carotene | 0.04 |

### Example 3

### Preparation of a Coated Frozen Stick

Frozen sticks are manufactured using the mixes prepared according to 1 and 2 of Example 1 above: first is measured out of all, the overrun frozen mix 1 constituting the core at −5 to −6° C. as indicated in Example 1 into the molds, which have been pre-cooled in a refrigerant bath, a stick is inserted therein, and then, when the core has solidified, it is extracted from the mold by reheating the surface, greatly cooled for example by plunging it into a liquid nitrogen bath, and coated by plunging it into a bath containing the non-overrun mix at a temperature of +2 to +4° C., and then the articles are wrapped and hardened at −30° C. to −35° C.

### Example 4

### Preparation of a Coated Frozen Stick

Frozen sticks are manufactured using a frozen mix prepared according to 1 of Example 1 above: first of all, the overrun frozen mix 1 constituting the core is measured out at −5 to −6° C. as indicated in Example 1 into the molds, which have been pre-cooled in a refrigerant bath, a stick is inserted therein, and then, when the core has solidified, it is extracted from the mold by reheating the surface, cooled, for example with a current of cold pulsed air, and dipped in a bath of chocolate covering, and then the articles are wrapped and hardened at −30° C. to −35° C.

What is claimed is:

1. A molded iced confectionery article based on water ice and having a soft-core texture, comprising:
i) a core of water ice containing 20 to 40% by weight of solids, and having a degree of overrun of 20 to 80% and a texture which is similar to that of an extruded ice-cream, and
ii) a shell of water ice having no overrun and containing 20 to 35% by weight of solids.

2. The article of claim 1, wherein the core has a degree of overrun of 30 to 50% and a solids content of 28 to 32% by weight.

3. The article of claim 1, wherein the core of water ice contains a stabilizing mixture with gelling properties in an amount of < or =0.5% by weight.

4. The article of claim 3, wherein the amount of stabilizing mixture is 0.3 to 0.4% by weight.

5. The article of claim 3, wherein the stabilizing mixture with gelling properties comprises xanthan gum and carob gum, xanthan gum being predominant, at a concentration of 0.25 to 0.35% by weight.

6. The article of claim 3, wherein, characterized in that in addition to the stabilizing mixture, the solids of the core originate:
for up to 20% by weight, from fruit puree, flavor or from colorant, and
for 20 to 27% by weight, from carbohydrates, including up to 7% by weight from glucose syrup.

7. The article of claim 1, wherein the solids of the shell constitute 25 to 30% by weight of the shell and originate:
for 3 to 5% by weight, from fruit puree, fruit juice, flavor or colorant,
for 0.35 to 0.45% by weight, from a stabilizer with viscosity-modifying properties, and
for 20 to 26% by weight, from carbohydrates.

8. The article of claim 7, wherein the stabilizer is guar gum.

9. The article of claim 1, in the form of an ice-lolly in which the core and the shell have a fruit-based flavor and color and either one optionally contains fruit.

10. The article of claim 9, wherein the fruit is present in a considerable amount and in the form of an extract, a puree, or pieces of fruit.

11. An iced confectionery article based on water ice and having a soft-core texture, comprising:
i) a core of water ice containing 20 to 40% by weight of solids, and having a degree of overrun of 20 to 80% and a texture which is similar to that of an extruded ice-cream, and
ii) a shell of water ice having no overrun, containing 20 to 35% by weight of solids, wherein the core contains edible inclusions that are 1 to 10 mm in size.

12. Iced confectionery article based on water ice and having a soft-core texture, comprising a core of water ice containing 20 to 40% by weight of solids, having a degree of overrun of 20 to 80% and a texture which is similar to that of an extruded ice-cream, wherein the core contains edible pieces that are 1 to 10 mm in size, and in that the core is coated with a fatty composition.

13. The article of claim 9, wherein the fatty composition is a chocolate covering

14. A Process-for preparing an iced confectionery article which comprises:
maintaining a mold in a refrigerated atmosphere, filling the mold with a liquid composition of water ice which has not been overrun and which is liquid,
cooling the mold so as to form an open shell of frozen water ice and an unfrozen center by freezing the liquid water ice composition in contact with an interior wall of the mold,
drawing off some or all of the liquid, unfrozen center to provide an open center portion of the article,
introducing a composition of water ice having a degree of overrun of 20 to 80% into the open center portion,
optionally, introducing a stick,
cooling the mold to freeze the overrun water ice and provide a core for the article,
if necessary, completing the formation of the shell by adding an additional amount of liquid water ice composition, before or after inserting the stick, and
hardening, and de-molding the article.

15. The process of claim 14, wherein the liquid water ice composition is measured out using a dispenser/distributor equipped with mixing means combined with an immersing measuring-out device, with the dispenser/distributor being maintained under pressure upstream of the measuring-out device, wherein the measuring-out device descends into the molds to near the bottoms of the molds to fill them as it is extracted from the mold to thus fill the molds without forming air pockets.

16. A process for preparing an iced confectionery article, which comprises:
maintaining a mold a refrigerated atmosphere,
filling the mold a liquid composition of water ice having a degree of overrun of 20 to 80% and which optionally contains, edible inclusions,
cooling the composition to form a core of the article,
if desired, introducing a stick,
hardening the core,
de-molding the hardened core, and
coating the core to form the article.

17. The process of claim 16, wherein the hardened core is coated with a liquid composition of water ice which has not been overrun or with chocolate.

18. The process of claim 16, wherein the composition of the core is filled into the mold at a temperature of between −2° C. and −6° C.

19. The process of claim 16, wherein the liquid water ice composition is measured out using a dispenser/distributor equipped with mixing means combined with an immersing measuring-out device, with the dispenser/distributor being maintained under pressure upstream of the measuring-out device, wherein the measuring-out device descends into the molds to near the bottoms of the molds to fill them as it is extracted from the mold to thus fill the molds without forming air pockets.

20. The process of claim 19, wherein the composition of the core is introduced into the dispenser/distributor under a gas pressure of 1.5 to 2 bar.
